(19) United States
(12) Patent Application Publication
(10) Pub. No.: US 2022/0214721 A1
(43) Pub. Date: Jul. 7, 2022

(54) KEYBOARD DEVICE

(71) Applicant: Primax Electronics Ltd., Taipei (TW)

(72) Inventors: Ming-Han Wu, Taipei (TW); Yi-Wei Chen, Taipei (TW)

(21) Appl. No.: 17/183,841

(22) Filed: Feb. 24, 2021

(30) Foreign Application Priority Data
Jan. 6, 2021 (TW) 110100501

(51) Int. Cl. G06F 1/16; H01H 13/86; H01H 13/06

(52) U.S. Cl. CPC G06F 1/1662; H01H 2223/003; H01H 13/06; H01H 13/86

(57) ABSTRACT

A keyboard device includes plural keys, a frame member and an elastic protective film. The frame member includes an outer frame and plural perforations. The keys are disposed within the outer frame. The outer frame has a first surface and a second surface opposed to the first surface. The plural perforations are in communication with the first surface and the second surface. The elastic protective film is fixed on the first surface of the frame member. The plural keys and the plural perforations are covered by the elastic protective film.

### FIELD OF THE INVENTION

The present invention relates to a keyboard device, and more particularly to keyboard device with a waterproof and dustproof function.

### BACKGROUND OF THE INVENTION

Conventionally, the keyboard user may place a layer of elastic protective film on a top surface of a keyboard device. Due to the elastic protective film, the keyboard device has the waterproof and dustproof functions. However, since the elastic protective film is not fixed on the keyboard device, the elastic protective film is readily shifted or slid when the keyboard device is operated by the user.

Moreover, when the elastic protective film is glued and fixed on the keyboard device, some drawbacks occur. For example, since bubbles are readily retained in the elastic protective film, the overall appearance and the flatness of the elastic protective film are adversely affected.

### SUMMARY OF THE INVENTION

The present invention provides a keyboard device. The keyboard device has a special structural design for facilitating attaching and fixing an elastic protective film on the keyboard device. In addition, when the elastic protective film is attached on the keyboard device, the possibility of generating bubbles in the elastic protective film will be largely reduced.

In accordance with an aspect of the present invention, a keyboard device is provided. The keyboard device includes plural keys, a frame member and an elastic protective film. The frame member includes an outer frame and plural perforations. The keys are disposed within the outer frame. The outer frame has a first surface and a second surface opposed to the first surface. The plural perforations are in communication with the first surface and the second surface. The elastic protective film is fixed on the first surface of the frame member. The plural keys and the plural perforations are covered by the elastic protective film.

In an embodiment, a thickness of the elastic protective film is in a range between 0.3 mm and 1 mm, the perforations are circular holes, and a diameter of each perforation is in a range between 0.3 mm and 0.5 mm.

In an embodiment, the elastic protective film is fixed on the first surface of the outer frame through an adhesive layer.

In an embodiment, the frame member further comprises inner ribs, and the plural inner ribs are disposed in seams between the adjacent keys. The elastic protective film is fixed on the inner ribs.

In an embodiment, the elastic protective film is attached on the inner ribs through an adhesive layer.

In an embodiment, the elastic protective film is made of silicone.

In an embodiment, the plural perforations are discretely arranged, and there is a spacing interval between every two adjacent perforations. The spacing interval is in a range between 0.3 mm and 1 mm.

In an embodiment, the outer frame includes a farther frame part, a nearer frame part, a left frame part and a right frame part. The farther frame part and the nearer frame part are connected with each other through the left frame part and the right frame part. A user's palm is permitted to be placed on the nearer frame part. The perforations are formed in at least one of the farther frame part, the nearer frame part, the left frame part and the right frame part.

In accordance with another aspect of the present invention, a keyboard device is provided. The keyboard device includes plural keys, a frame member and an elastic protective film. The frame member includes an outer frame and plural grooves. The plural keys are disposed within the outer frame. The outer frame has a first surface and a second surface opposed to the first surface. The plural grooves are extended from the first surface to the second surface, but not contacted with the second surface. The elastic protective film is fixed on the first surface of the frame member. The plural keys and the plural grooves are covered by the elastic protective film.

In an embodiment, a thickness of the elastic protective film is in a range between 0.3 mm and 1 mm, and a width of each groove is in a range between 0.3 mm and 0.5 mm.

In an embodiment, the elastic protective film is fixed on the first surface of the outer frame through an adhesive layer.

In an embodiment, the frame member further comprises inner ribs, and the plural inner ribs are disposed in seams between the adjacent keys. The elastic protective film is fixed on the inner ribs.

In an embodiment, the elastic protective film is attached on the inner ribs through an adhesive layer.

In an embodiment, the elastic protective film is made of silicone.

In an embodiment, the plural grooves are discretely arranged, and the plural grooves are not in communication with each other.

In an embodiment, the plural grooves are in parallel with each other, and a spacing interval between every two adjacent grooves is in a range between 0.3 mm and 1 mm.

In an embodiment, a depth of each groove is smaller than or equal to a half of a thickness of the frame member.

In an embodiment, a depth of each groove is 0.6 mm.

In an embodiment, a ratio of a depth to a width of each groove is 2:1.

In an embodiment, the outer frame comprises a farther frame part, a nearer frame part, a left frame part and a right frame part. The farther frame part and the nearer frame part are connected with each other through the left frame part and the right frame part. A user's palm is permitted to be placed on the nearer frame part. The grooves are formed in at least one of the farther frame part, the left frame part, the right frame part and the nearer frame part.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a keyboard device according to a first embodiment of the present invention;

FIG. 2 is a schematic perspective view illustrating the keyboard device as shown in FIG. 1;

FIG. 3 is a schematic cross-sectional view illustrating the keyboard device as shown in FIG. 1 and taken along the line 3-3;

FIG. 4 is a schematic enlarged view illustrating a portion of the keyboard device as shown in FIG. 3;

FIG. 5 is a schematic enlarged view illustrating a variant example of the structure as shown in FIG. 4;

FIG. 6 is a schematic exploded view illustrating a keyboard device according to a second embodiment of the present invention;

FIG. 7 is a schematic perspective view illustrating the keyboard device as shown in FIG. 6;

FIG. 8 is a schematic cross-sectional view illustrating the keyboard device as shown in FIG. 6 and taken along the line 8-8;

FIG. 9 is a schematic enlarged view illustrating a portion of the keyboard device as shown in FIG. 8; and

FIG. 10 is a schematic enlarged view illustrating a variant example of the structure as shown in FIG. 9.

### DETAILED DESCRIPTION OF THE PREFERRED EMBODIMENT

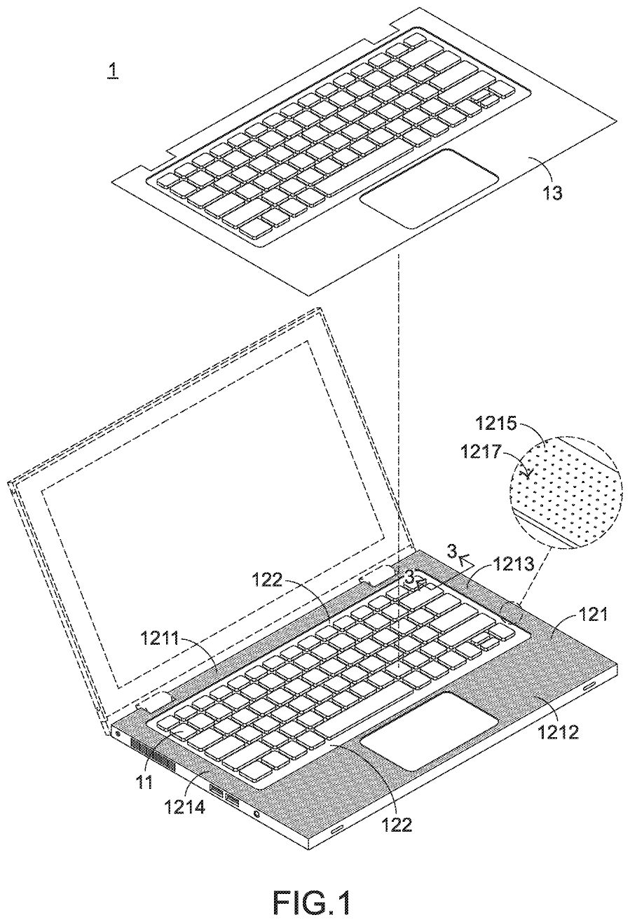

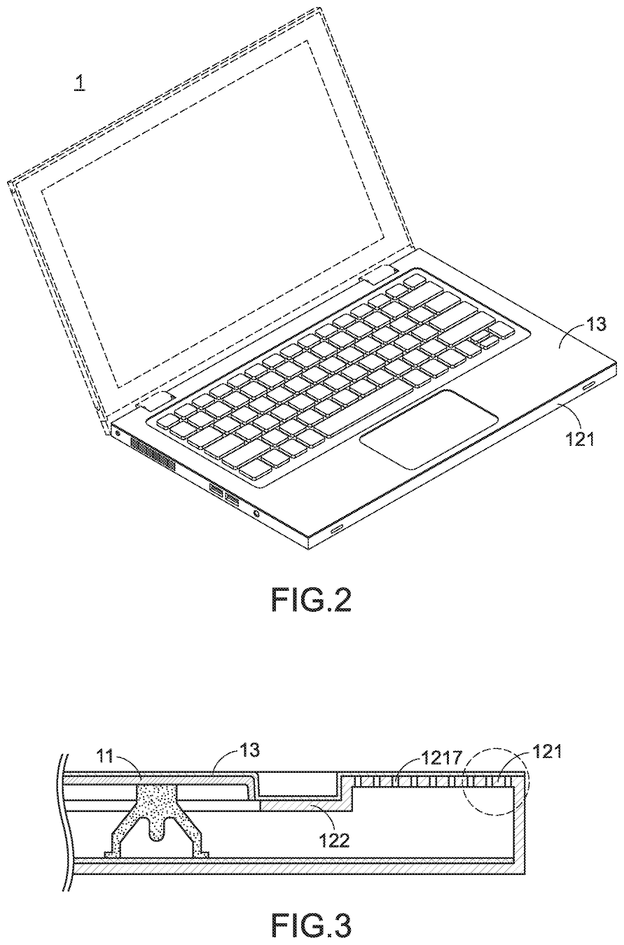

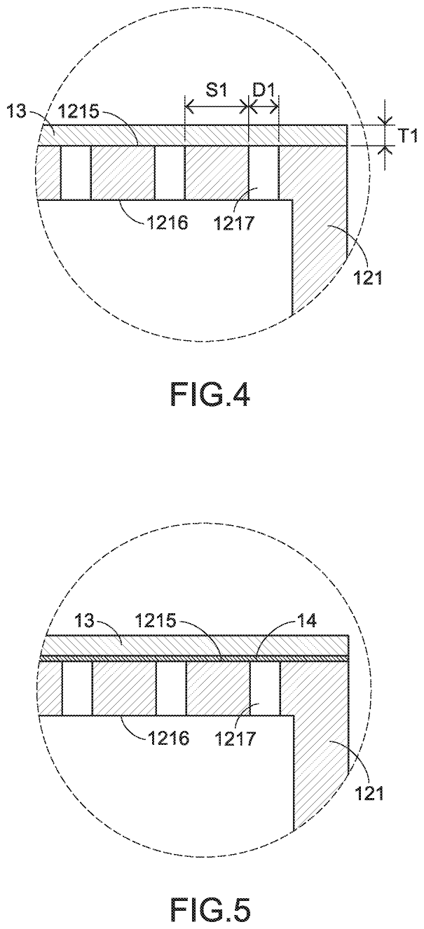

In a first embodiment, the present invention provides a keyboard device. The keyboard device is a wired keyboard device or a wireless keyboard device. As shown in FIG. 1, the keyboard device is used as the keyboard device of a notebook computer. It is noted that the applications of the keyboard device of the present invention are not restricted. A keyboard device according to the first embodiment of the present invention will be illustrated with reference to FIGS. 1, 2, 3 and 4. FIG. 1 is a schematic exploded view illustrating a keyboard device according to a first embodiment of the present invention. FIG. 2 is a schematic perspective view illustrating the keyboard device as shown in FIG. 1. FIG. 3 is a schematic cross-sectional view illustrating the keyboard device as shown in FIG. 1 and taken along the line 3-3. FIG. 4 is a schematic enlarged view illustrating a portion of the keyboard device as shown in FIG. 3. The keyboard device 1 comprises plural keys 11, a frame member 12 and an elastic protective film 13.

The frame member 12 comprises an outer frame 121. The outer frame 121 comprises a farther frame part 1211, a nearer frame part 1212, a left frame part 1213 and a right frame part 1214. The farther frame part 1211 and the nearer frame part 1212 are connected with each other through the left frame part 1213 and the right frame part 1214. The farther frame part 1211 and the nearer frame part 1212 are determined according to the distances from the user or the positions relative to the user when the keyboard device 1 is operated. The farther frame part 1211 is away from the user. The nearer frame part 1212 is closer to the user. When the keyboard device 1 is operated by the user, the palm of the user can be placed on the nearer frame part 1212. Moreover, the outer frame 121 has a first surface 1215 and a second surface 1216. The first surface 1215 and the second surface 1216 are opposed to each other. For example, in case that the first surface 1215 is a top surface of the outer frame 121, the second surface 1216 is a bottom surface of the outer frame 121 or an inner surface of the frame member 12.

When the frame member 12 and the plural keys 11 are assembled with each other, the keys 11 are disposed within the outer frame 121 and enclosed by the outer frame 121.

In the keyboard device 1, a layer of elastic protective film 13 that is made of silicone is fixed on the frame member 12. Consequently, the keyboard device 1 has the waterproof and dustproof function. The elastic protective film 13 has toughness and elasticity. After the elastic protective film 13 undergoes deformation, the elastic protective film 13 can be restored to its original shape. Moreover, the surface of the elastic protective film 13 does not adsorb dust or stick to dust. Consequently, the elastic protective film 13 has an anti-sticking function.

In accordance with a feature of the present invention, the keyboard device 1 has a special design of facilitating attaching and fixing the elastic protective film 13 on the frame member 12. Consequently, during the attaching process, the possibility of generating bubbles in the elastic protective film 13 will be largely reduced. For achieving the above function, the outer frame 121 of the frame member 12 comprises perforations 1217. The perforations 1217 are in communication with the first surface 1215 and the second surface 1216 of the outer frame 121. While the elastic protective film 13 is attached on the outer frame 121, the air can be sequentially exited out through the perforations 1217 along the attaching direction, or the air can be moved from the first surface 1215 to the second surface 1216 through the perforations 1217 and then exited out of other openings of the frame member 12. Consequently, bubbles will not be retained in the elastic protective film 13, or bubbles will not disorderly flow in the elastic protective film 13. In this way, the attaching process of the elastic protective film 13 can be performed more smoothly. Moreover, when the elastic protective film 13 is attached and fixed on the first surface 1215, the perforations 1217 are covered by the elastic protective film 13 and the flatness of the elastic protective film 13 is maintained.

In the keyboard device 1 of this embodiment, the perforations 1217 are formed in at least one of the farther frame part 1211, the nearer frame part 1212, the left frame part 1213 and the right frame part 1214.

Please refer to FIGS. 3 and 4 again. In an embodiment, the thickness T1 of the elastic protective film 13 is in the range between 0.3 mm and 1 mm, the perforations 1217 are circular holes, and the diameter D1 of each perforation 1217 is in the range between 0.3 mm and 0.5 mm. Moreover, in order to maintain the flatness of the elastic protective film 13 on the frame member 12 and reduce the possibility of generating bubbles in the attaching process, the perforations 1217 are discretely arranged. In addition, there is a spacing interval S1 between every two adjacent perforations 1217. The spacing interval S1 is in the range between 0.3 mm and 1 mm. It is preferred that a ratio of the spacing interval S1 between every two adjacent perforations 1217 to the diameter S1 of the perforation 1217 is 1:1.

In an embodiment, the frame member 12 further comprises inner ribs 122. The inner ribs 122 are disposed within the outer frame 121 and enclosed by the outer frame 121. The plural keys 11 are separated from each other by the inner ribs 122. When the frame member 12 and the plural keys 11 are assembled with each other, the inner ribs 122 are disposed in the seams between the adjacent keys 11.

In an embodiment, the outer frame 121 and the inner ribs 122 are integrally formed as a one-piece structure. Alternatively, the outer frame 121 and the inner ribs 122 are separate components.

In an embodiment, the elastic protective film 13 is fixed on the outer frame 121 of the frame member 12. Optionally, the elastic protective film 13 is further fixed on the inner ribs 122 or the surfaces of the keys 11. That is, the installation position of the elastic protective film 13 may be determined according to the practical requirements. In case that the elastic protective film 13 is required to be fixed on the inner ribs 122 or the keys 11, the elastic protective film 13 may also have the three-dimensional structures as shown in FIG. 1 to match the profiles of the corresponding inner ribs 122 and the corresponding keys 11.

In an embodiment, the elastic protective film 13 has adhesivity, and thus the elastic protective film 13 is directly fixed on the first surface 1215 of the outer frame 121, the inner ribs 122 or the keys 11. It is noted that numerous modifications and alterations may be made while retaining the teachings of the invention. FIG. 5 is a schematic enlarged view illustrating a variant example of the structure as shown in FIG. 4. As shown in FIG. 5, the elastic protective film 13 is fixed on the first surface 1215 of the outer frame 121, the inner ribs 122 or the keys 11 through an adhesive layer 14.

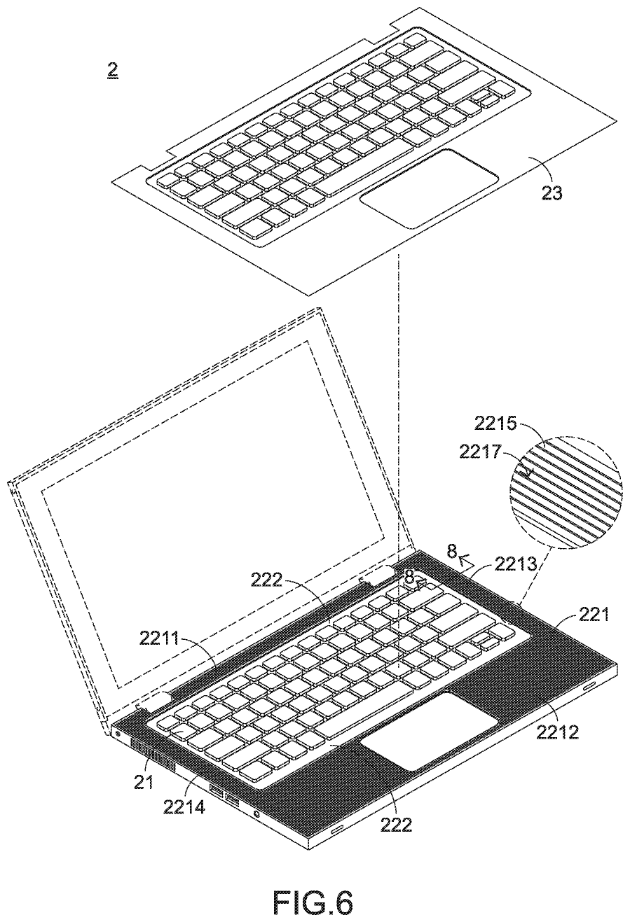

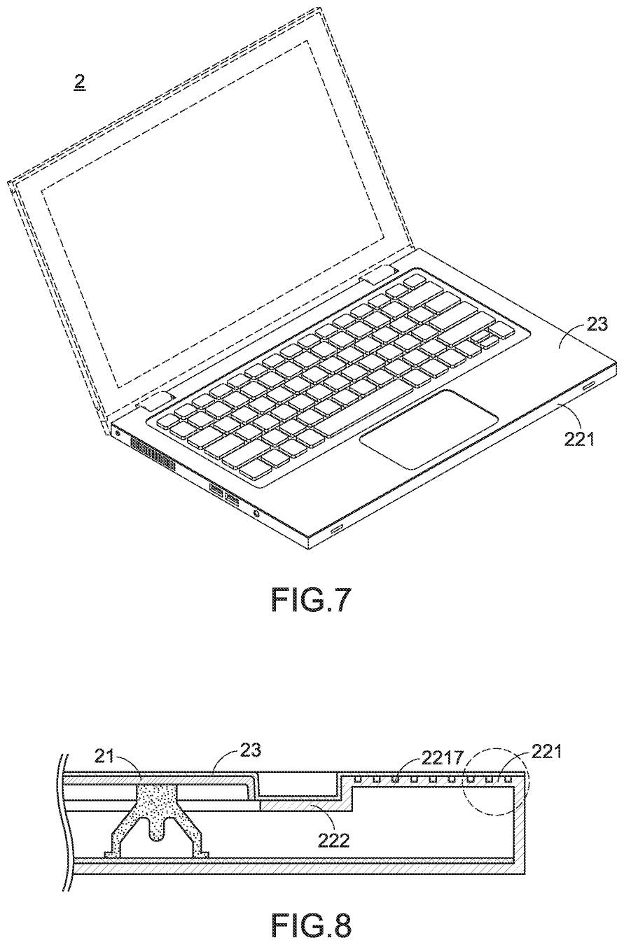

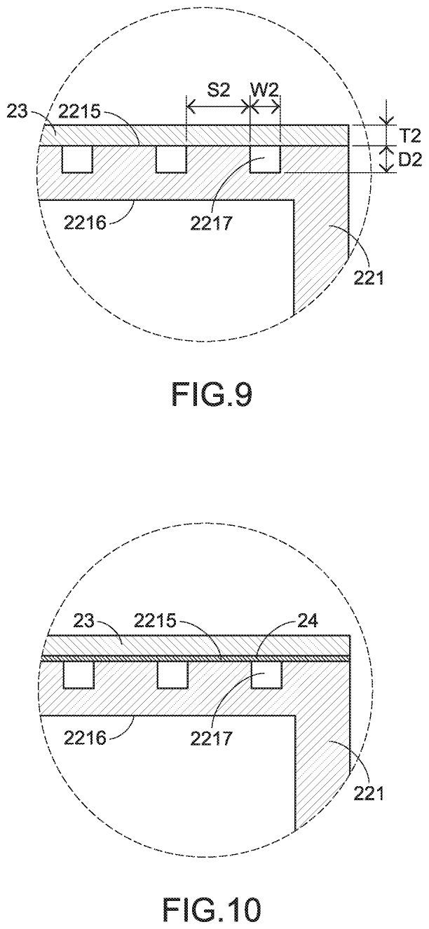

In a second embodiment, the present invention provides a keyboard device. The keyboard device is a wired keyboard device or a wireless keyboard device. As shown in FIG. 6, the keyboard device is used as the keyboard device of a notebook computer. It is noted that the applications of the keyboard device of the present invention are not restricted. A keyboard device according to the second embodiment of the present invention will be illustrated with reference to FIGS. 6, 7, 8 and 9. FIG. 6 is a schematic exploded view illustrating a keyboard device according to a second embodiment of the present invention. FIG. 7 is a schematic perspective view illustrating the keyboard device as shown in FIG. 6. FIG. 8 is a schematic cross-sectional view illustrating the keyboard device as shown in FIG. 6 and taken along the line 8-8. FIG. 9 is a schematic enlarged view illustrating a portion of the keyboard device as shown in FIG. 8. The keyboard device 2 comprises plural keys 21, a frame member 22 and an elastic protective film 23.

The frame member 22 comprises an outer frame 221. The outer frame 221 comprises a farther frame part 2211, a nearer frame part 2212, a left frame part 2213 and a right frame part 2214. The farther frame part 2211 and the nearer frame part 2212 are connected with each other through the left frame part 2213 and the right frame part 2214. The farther frame part 2211 and the nearer frame part 2212 are determined according to the distances from the user or the positions relative to the user when the keyboard device 2 is operated. The farther frame part 2211 is away from the user. The nearer frame part 2212 is closer to the user. When the keyboard device 2 is operated by the user, the palm of the user can be placed on the nearer frame part 2212. Moreover, the outer frame 221 has a first surface 2215 and a second surface 2216. The first surface 2215 and the second surface 2216 are opposed to each other. For example, in case that the first surface 2215 is a top surface of the outer frame 221, the second surface 2216 is a bottom surface of the outer frame 221 or an inner surface of the frame member 22.

When the frame member 22 and the plural keys 21 are assembled with each other, the keys 21 are disposed within the outer frame 221 and enclosed by the outer frame 221.

In the keyboard device 2, a layer of elastic protective film 23 that is made of silicone is fixed on the frame member 22. Consequently, the keyboard device 2 has the waterproof and dustproof function. The elastic protective film 23 has toughness and elasticity. After the elastic protective film 23 undergoes deformation, the elastic protective film 23 can be restored to its original shape. Moreover, the surface of the elastic protective film 23 does not adsorb dust or stick to dust. Consequently, the elastic protective film 23 has an anti-sticking function.

In accordance with a feature of the present invention, the keyboard device 2 has a special design of facilitating attaching and fixing the elastic protective film 23 on the frame member 22. Consequently, during the attaching process, the possibility of generating bubbles in the elastic protective film 23 will be largely reduced. For achieving the above function, the outer frame 221 of the frame member 22 comprises plural grooves 2217. The grooves 2217 are formed in the first surface 2215 of the outer frame 221 and extended in the direction toward the second surface 2216 of the outer frame 221. The grooves 2217 are not contacted with the second surface 2216. While the elastic protective film 23 is attached on the outer frame 221, the air can be sequentially exited out through the grooves 2217 along the installation direction of the grooves 2217. Consequently, bubbles will not be retained in the elastic protective film 23, or bubbles will not disorderly flow in the elastic protective film 23. In this way, the attaching process of the elastic protective film 23 can be performed more smoothly. Moreover, when the elastic protective film 23 is attached and fixed on the first surface 2215, the grooves 2217 are covered by the elastic protective film 23 and the flatness of the elastic protective film 23 is maintained.

In the keyboard device 2 of this embodiment, the grooves 2217 are formed in at least one of the farther frame part 2211, the nearer frame part 2212, the left frame part 2213 and the right frame part 2214. Preferably, the grooves 2217 are formed in the farther frame part 2211, the left frame part 2213 or the right frame part 2214.

Please refer to FIGS. 8 and 9. In an embodiment, the thickness T2 of the elastic protective film 23 is in the range between 0.3 mm and 1 mm. The width W2 of the groove 2217 is in the range between 0.3 mm and 0.5 mm. The depth D2 of the groove 2217 is larger than or equal to 0.3 mm, and smaller than or equal to a half of the thickness of the frame member 22. Preferably, the depth D2 of the groove 2217 is 0.6 mm. It is preferred that a ratio of the depth D2 of the groove 2217 to the width W2 of the groove 2217 is 2:1.

Moreover, in order to maintain the flatness of the elastic protective film 23 on the frame member 22 and reduce the possibility of generating bubbles in the attaching process, the plural grooves 2217 are discretely arranged. For example, the plural grooves 2217 are in parallel with each other. In addition, there is a spacing interval S2 between every two adjacent grooves 2217. The spacing interval S2 is in the range between 0.3 mm and 1 mm. In another embodiment, the adjacent grooves 2217 are not in parallel with each other as long as the adjacent grooves 2217 are not in contact with or in communication with each other.

In an embodiment, the frame member 22 further comprises inner ribs 222. The inner ribs 222 are disposed within the outer frame 221 and enclosed by the outer frame 221. The plural keys 21 are separated from each other by the inner ribs 222. When the frame member 22 and the plural keys 21 are assembled with each other, the inner ribs 222 are disposed in the seams between the adjacent keys 21.

In an embodiment, the outer frame 221 and the inner ribs 222 are integrally formed as a one-piece structure. Alternatively, the outer frame 221 and the inner ribs 222 are separate components.

In an embodiment, the elastic protective film 23 is fixed on the outer frame 221 of the frame member 22. Optionally, the elastic protective film 23 is further fixed on the inner ribs 222 or the surfaces of the keys 21. That is, the installation position of the elastic protective film 23 may be determined according to the practical requirements. In case that the elastic protective film 23 is required to be fixed on the inner ribs 222 or the keys 21, the elastic protective film 23 may also have the three-dimensional structures as shown in FIG. 6 to match the profiles of the corresponding inner ribs 222 and the corresponding keys 21.

In an embodiment, the elastic protective film 23 has adhesivity, and thus the elastic protective film 23 is directly fixed on the first surface 2215 of the outer frame 221, the inner ribs 222 or the keys 21. It is noted that numerous modifications and alterations may be made while retaining the teachings of the invention. FIG. 10 is a schematic enlarged view illustrating a variant example of the structure as shown in FIG. 9. As shown in FIG. 10, the elastic protective film 23 is fixed on the first surface 2215 of the outer frame 221, the inner ribs 222 or the keys 21 through an adhesive layer 24.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A keyboard device, comprising:
plural keys;
a frame member comprising an outer frame and plural perforations, wherein the plural keys are disposed within the outer frame, the outer frame has a first surface and a second surface opposed to the first surface, and the plural perforations are in communication with the first surface and the second surface; and
an elastic protective film fixed on the first surface of the frame member, wherein the plural keys and the plural perforations are covered by the elastic protective film.

2. The keyboard device according to claim 1, wherein a thickness of the elastic protective film is in a range between 0.3 mm and 1 mm, the perforations are circular holes, and a diameter of each perforation is in a range between 0.3 mm and 0.5 mm.

3. The keyboard device according to claim 1, wherein the elastic protective film is fixed on the first surface of the outer frame through an adhesive layer.

4. The keyboard device according to claim 1, wherein the frame member further comprises inner ribs, and the plural inner ribs are disposed in seams between the adjacent keys, wherein the elastic protective film is fixed on the inner ribs.

5. The keyboard device according to claim 4, wherein the elastic protective film is attached on the inner ribs through an adhesive layer.

6. The keyboard device according to claim 1, wherein the elastic protective film is made of silicone.

7. The keyboard device according to claim 1, wherein the plural perforations are discretely arranged, and there is a spacing interval between every two adjacent perforations, wherein the spacing interval is in a range between 0.3 mm and 1 mm.

8. The keyboard device according to claim 1, wherein the outer frame comprises a farther frame part, a nearer frame part, a left frame part and a right frame part, wherein the farther frame part and the nearer frame part are connected with each other through the left frame part and the right frame part, and a user's palm is permitted to be placed on the nearer frame part, wherein the perforations are formed in at least one of the farther frame part, the nearer frame part, the left frame part and the right frame part.

9. A keyboard device, comprising:
plural keys;
a frame member comprising an outer frame and plural grooves, wherein the plural keys are disposed within the outer frame, and the outer frame has a first surface and a second surface opposed to the first surface, wherein the plural grooves are extended from the first surface to the second surface, but not contacted with the second surface; and
an elastic protective film fixed on the first surface of the frame member, wherein the plural keys and the plural grooves are covered by the elastic protective film.

10. The keyboard device according to claim 9, wherein a thickness of the elastic protective film is in a range between 0.3 mm and 1 mm, and a width of each groove is in a range between 0.3 mm and 0.5 mm.

11. The keyboard device according to claim 9, wherein the elastic protective film is fixed on the first surface of the outer frame through an adhesive layer.

12. The keyboard device according to claim 9, wherein the frame member further comprises inner ribs, and the plural inner ribs are disposed in seams between the adjacent keys, wherein the elastic protective film is fixed on the inner ribs.

13. The keyboard device according to claim 12, wherein the elastic protective film is attached on the inner ribs through an adhesive layer.

14. The keyboard device according to claim 9, wherein the elastic protective film is made of silicone.

15. The keyboard device according to claim 9, wherein the plural grooves are discretely arranged, and the plural grooves are not in communication with each other.

16. The keyboard device according to claim 9, wherein the plural grooves are in parallel with each other, and a spacing interval between every two adjacent grooves is in a range between 0.3 mm and 1 mm.

17. The keyboard device according to claim 9, wherein a depth of each groove is smaller than or equal to a half of a thickness of the frame member.

18. The keyboard device according to claim 9, wherein a depth of each groove is 0.6 mm.

19. The keyboard device according to claim 9, wherein a ratio of a depth to a width of each groove is 2:1.

20. The keyboard device according to claim 9, wherein the outer frame comprises a farther frame part, a nearer frame part, a left frame part and a right frame part, wherein the farther frame part and the nearer frame part are connected with each other through the left frame part and the right frame part, and a user's palm is permitted to be placed on the nearer frame part, wherein the grooves are formed in at least one of the farther frame part, the left frame part, the right frame part and the nearer frame part.
